(19) United States
(12) Patent Application Publication
(10) Pub. No.: US 2008/0117207 A1
(43) Pub. Date: May 22, 2008

(54) Copying and editing method in computer

(75) Inventors: Pao-Ta YU, Tapei County (TW); Yuan-Hou CHANG, Tapei County (TW)

Correspondence Address: BIRCH STEWART KOLASCH & BIRCH, PO BOX 747, FALLS CHURCH, VA, 22040-0747, US

(73) Assignee: XENGDA TECHNOLOGY CO., LTD.

(21) Appl. No.: 11/896,088

(22) Filed: Aug. 29, 2007

(30) Foreign Application Priority Data
Nov. 16, 2006 (TW) 095142351

(51) Int. Cl. G06T 15/40

(52) U.S. Cl. 345/421

(57) ABSTRACT

The present invention includes steps of: acquiring a first image information; making the first image information to have a hidden attribute; acquiring a second image information in a displaying format; acquiring the first image information and the second image information to perform a blending operation for producing a third image information in a displaying format to output to a first display device; editing the second image information in the displaying format through the third image information in the displaying format displayed on the first display device; and drawing the edited second image information to produce a drawn image information in the displaying format, thereby, as editing the second image information, the third image information which is displayed on the first display device and contains the first image information can act as reference, so as to avoid the drawn image information from containing the first image information.

### FIELD OF THE INVENTION

The present invention is related to an editing method in a computer, in which a display simultaneously displays a draft image and an editing image in overlap, so that the user can edit the editing image by referencing to the draft image, and only the edited image with draft image is drawn out.

### BACKGROUND OF THE INVENTION

When the user utilizes a computer for demonstrating, the presentation software such as PowerPoint is always used for playing images. If the user needs operation or figure drawing for description, a vector tracing software has to be used for processing a free-hand operation or figure drawing. However, if the user has to operate an unfamiliar formula when processing a free-hand operation or figure drawing, the demonstration might not be successful. Besides, if the user does not notice the area of the handwriting or of the hand drawn figure and write or draw in an unorganized way, then it might cause a disordered picture which also bothers the user.

Alternatively, another method is to pre-draw the draft by PowerPoint or other software for being the reference of demonstration. However, in the software described above, the draft only can be shown with the picture used for demonstration at the same time and the user only can read the draft according to the display, which actually is not a great manner. Therefore, how to provide the user a software which can show the draft for reference and also can prevent the draft from showing in the demonstration is really a significant issue.

### SUMMARY OF THE INVENTION

The object of the present invention is to provide an editing method in a computer, in which a display can simultaneously display a draft image and an editing image in overlap, so that the user can edit the editing image by referencing to the draft image, and only the edited image is drawn out for demonstration.

For achieving the object described above, the present invention provides a copying and editing method in a computer, including steps of: acquiring a first image information, wherein the first image information is defined to have a hiding attribute; making the first image information to have a hiding format through setting the hiding attribute of the first image information; acquiring a second image information with a displaying format, wherein the second image information is defined to have a hiding attribute and is set to have a displaying format through setting the hidden attribute; acquiring the first image information in the hidden format and the second image information in the displaying format to perform a blending operation for producing a third image information in a displaying format to output to a first display device, wherein the displaying picture of the third image information contains the first image information and the second image information which go through the image operation; editing the second image information in the displaying format through the third image information in the displaying format displayed on the first display device; and drawing the edited second image information to produce a drawn image information, thereby, as editing the second image information, the third image information which is displayed on the first display device and contains the first image information can act as reference, so as to avoid the drawn image information from containing the first image information.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic view showing the data structure of a preferred embodiment according to the present invention;

FIG. 2 is a flow chart showing a preferred embodiment according to the present invention;

FIG. 3 is a schematic view showing the data structure of another preferred embodiment according to the present invention;

FIG. 4 is a schematic view showing the picture of a first image information in a preferred embodiment according to the present invention;

FIG. 5 is a schematic view showing the picture of a second image information before editing in a preferred embodiment according to the present invention;

FIG. 6 is a schematic view showing the picture of a third image information, which combines FIG. 4 and FIG. 5, in a preferred embodiment according to the present invention;

FIG. 7 is a schematic view showing the picture of a second image information during editing in a preferred embodiment according to the present invention;

FIG. 8 is a schematic view showing the picture of a third image information, which combines FIG. 4 and FIG. 7, in a preferred embodiment according to the present invention;

FIG. 9 is a schematic view showing the picture of a second image information after editing in a preferred embodiment according to the present invention; and

FIG. 10 is a schematic view showing the picture of a third image information, which combines FIG. 4 and FIG. 9, in a preferred embodiment according to the present invention.

### DESCRIPTION OF THE PREFERRED EMBODIMENT

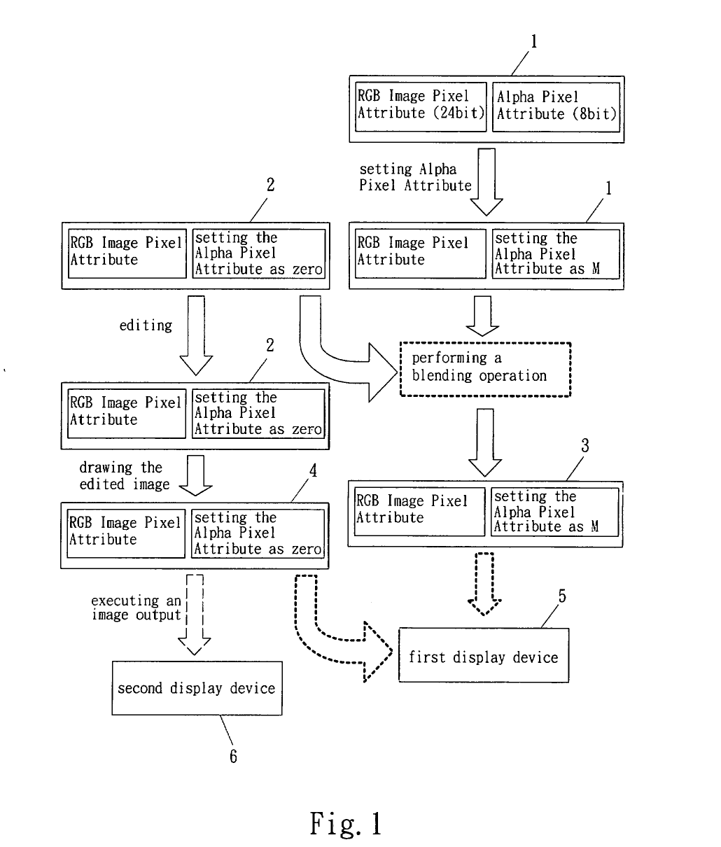

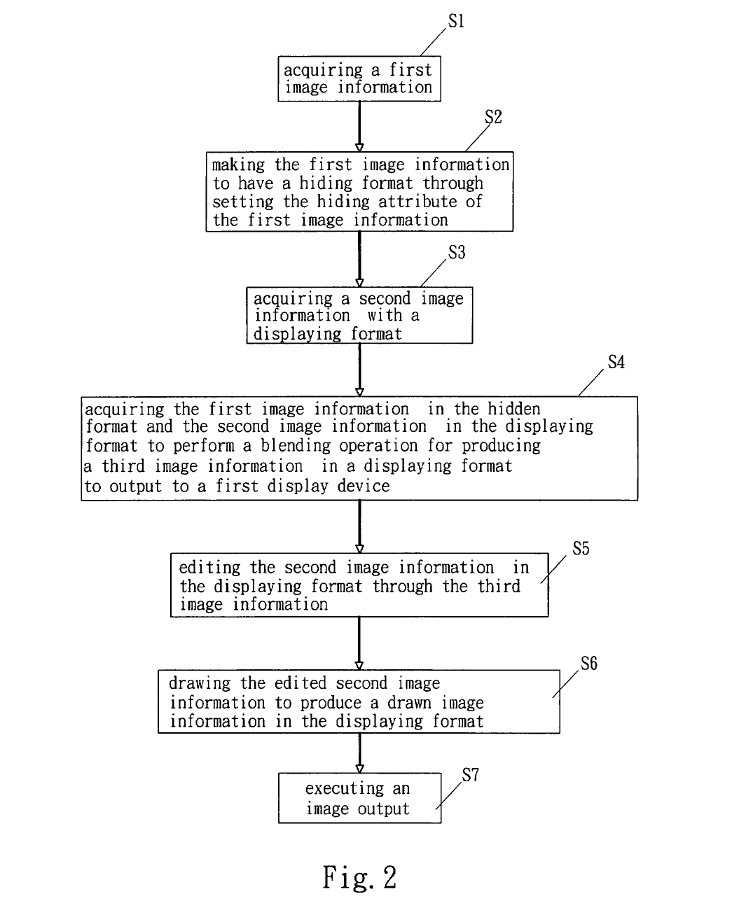

Please refer to FIG. 1 and FIG. 2, which are respectively a schematic view of data structure and a flow chart showing a preferred embodiment according to the present invention. As shown, the present invention provides a copying and editing method in a computer, includes steps of:

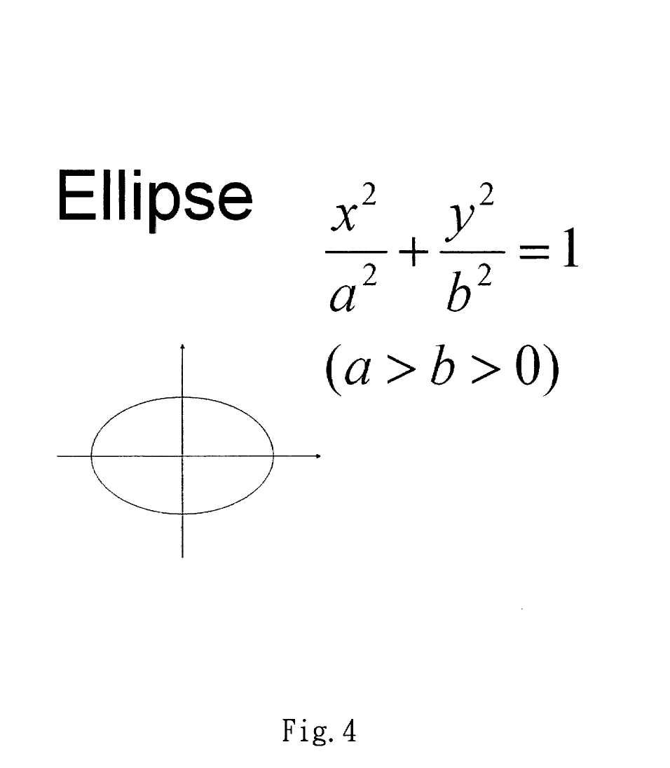

acquiring a first image information 1 (S1), wherein the first image information 1 (please refer to FIG. 4) is defined to have a displaying attribute and a hiding attribute. In this embodiment, the first image information 1 is a draft information for referencing and the first image information 1 is a 32-bits VGA (Video Graphics Array), in which the displaying attribute is a 24-bits RGB image pixel attribute which is constituted by a 8-bit red image pixel attribute, a 8-bit green image pixel attribute and a 8-bit blue image pixel attribute, and the hiding attribute is a 8-bit alpha pixel attribute;

making the first image information 1 to have a hiding format through setting the hiding attribute of the first image information 1 (S2), in which the first image information 1 is set to be the hidden format through setting the Alpha Pixel Attribute as M, wherein 1≦M≦255;

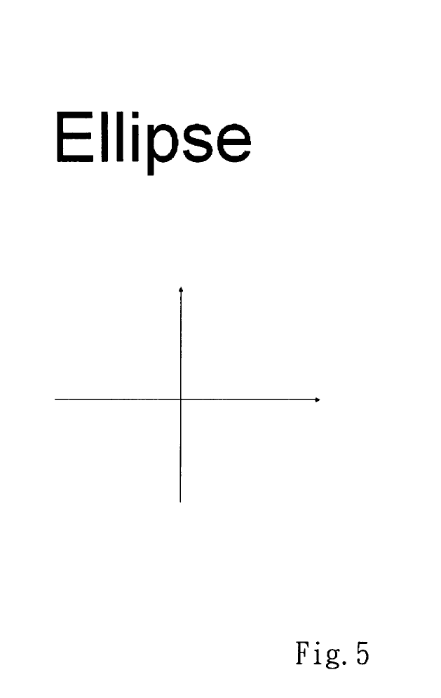

acquiring a second image information 2 with a displaying format (S3), wherein the second image information 2 is also defined to have a displaying attribute and a hiding attribute and can have a displaying format through setting the attribute, in which the second image information 2 is an editing image (please refer to FIG. 5) for providing to the user to edit, and the second image information 2, like the first image information 1, also is a 32-bit VGA (Video Graphics Array) with the displaying attribute being a 24-bits RGB image pixel attribute and the hiding attribute being a 8-bit alpha pixel attribute, and through setting the attribute of the 8-bit alpha pixel attribute as zero, the second image information 2 can have a displaying format;

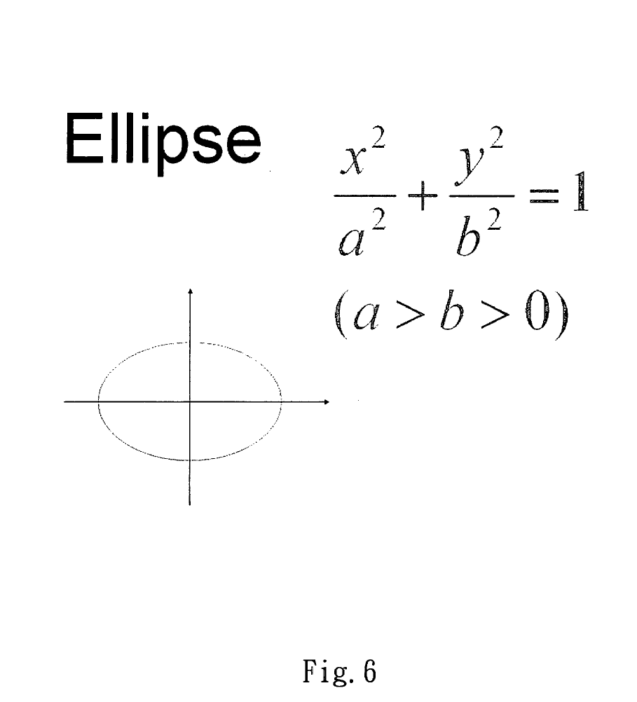

acquiring the first image information 1 in the hidden format and the second image information 2 in the displaying format to perform a blending operation for producing a third image information 3 in a displaying format to output to a first display device 5 (S4), wherein the displaying picture of the third image information 3 includes the first image information 1 and the second image information 2 which go through the image operation (please refer to FIG. 6), for example, when a translucent yellow pixel attribute (which has a non-zero alpha pixel attribute) covers on an opaque blue pixel attribute (whose alpha pixel attribute is zero), after blending, a green pixel attribute (whose alpha pixel attribute is zero) is generated, so that, after blending, the first image information in the hidden format (which has a non-zero alpha pixel attribute) and the second image information in the displaying format (whose alpha pixel attribute is zero) can produce the third image information in a displaying format (whose alpha pixel attribute is zero), in which the third image information 3 is constituted by lapping and blending the first image information 1 and the second image information 2 so as to provide the user the overlapped first and second image information 1, 2 for viewing at the same time;

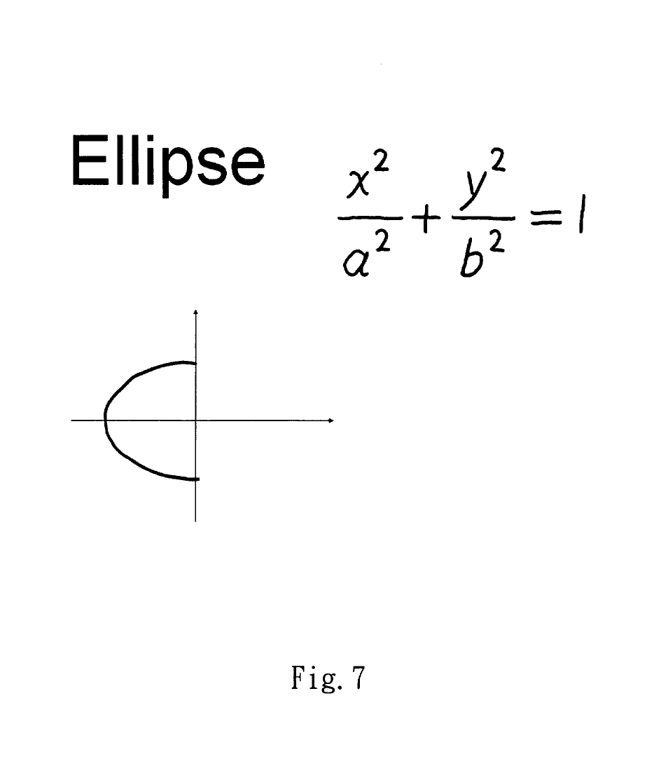

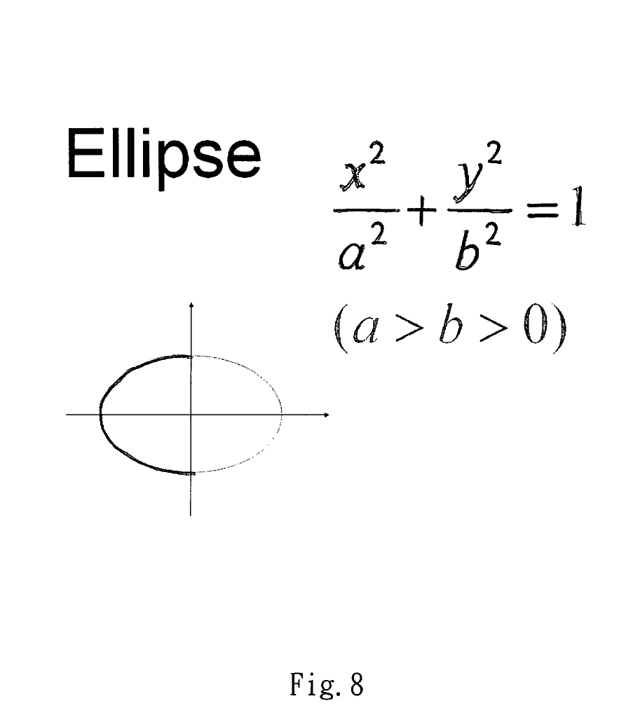

editing the second image information 2 in the displaying format through the third image information 3 in the displaying format displayed on the first display device 5 (S5) (please refer to FIG. 7), wherein the third image information 3 is formed by lapping and blending the first image information 1 and the second image information 2, so that when watching the third image information on the first display device 5, the user can edit the second image information 2 (which is set to be displayed) by referring to the draft information contained in the first image information 1 (which is set to be hidden) (please refer to FIG. 8), in which the second image information 2 can be edited by, not limited, writing and/or drawing, and wherein the first image information 1 is set to have a transparent attribute, thereby the first image information 1 will not be altered by the editing from the user and the editing from the user via the computer can pass through the first image information 1 and direct to the second image information 2 so as to edit the second image information 2, in which the transparent editing mode is depending on Windows operation model, for example, the user can utilize the mouse to edit, the system decides the editing is directed to the picture (namely, the third image information 3) so as to transmit the editing to the first image information 1 and the second image information 2, and since the first image information 1 has the transparent attribute, the editing will not be transmitted to the first image information 1 but passed through the first image information 1 and arrived at the second image information 2; and

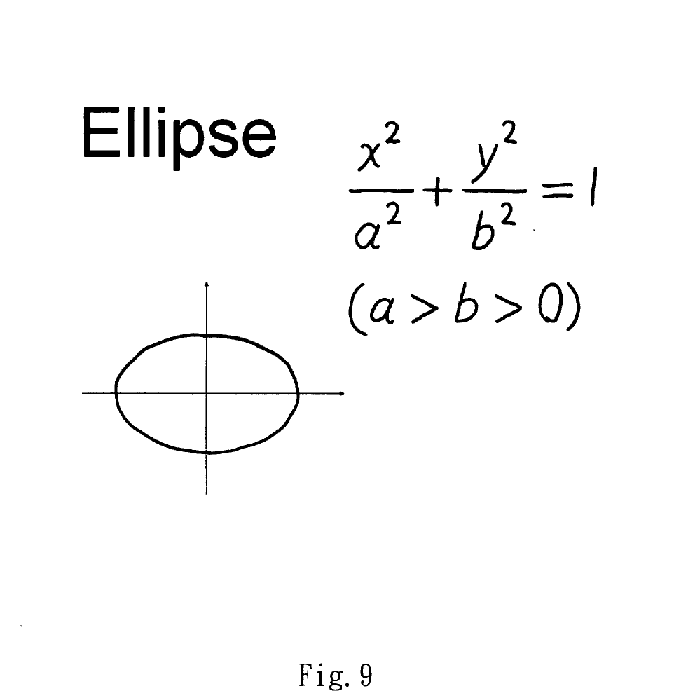

drawing the edited second image information 2 to produce a drawn image information 4 in the displaying format (S6) (please refer to FIG. 9), wherein the drawing method includes, but not limited, the continuous image recording (namely the video mode) and/or the independent image drawing (namely the camera mode), in which the second image information 2 is obtained by, before blending, only drawing the image information which has the displaying format (namely, the alpha pixel attribute is set as zero).

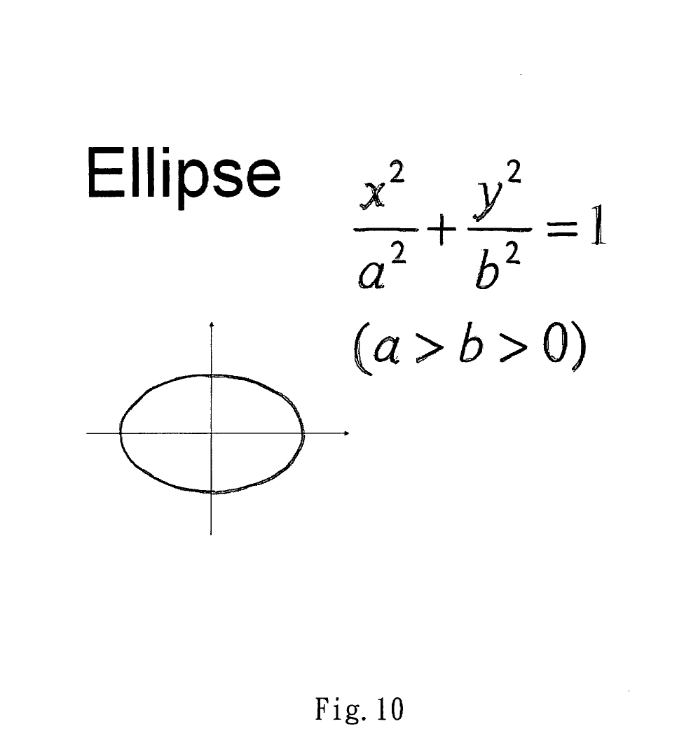

Furthermore, the drawn image information 4 can execute an image output (S7) to a second display device 6 for showing, wherein, of course, the drawn image information 4 also can be displayed on the first display device 5, for example, the first display device 5 can utilize the PIP (picture in picture) mode, for instance, to show the third image information 3 and the drawn image information 4 at the same time, or can be switched to display the third image information 3 (please refer to FIG. 10) or the drawn image information 4.

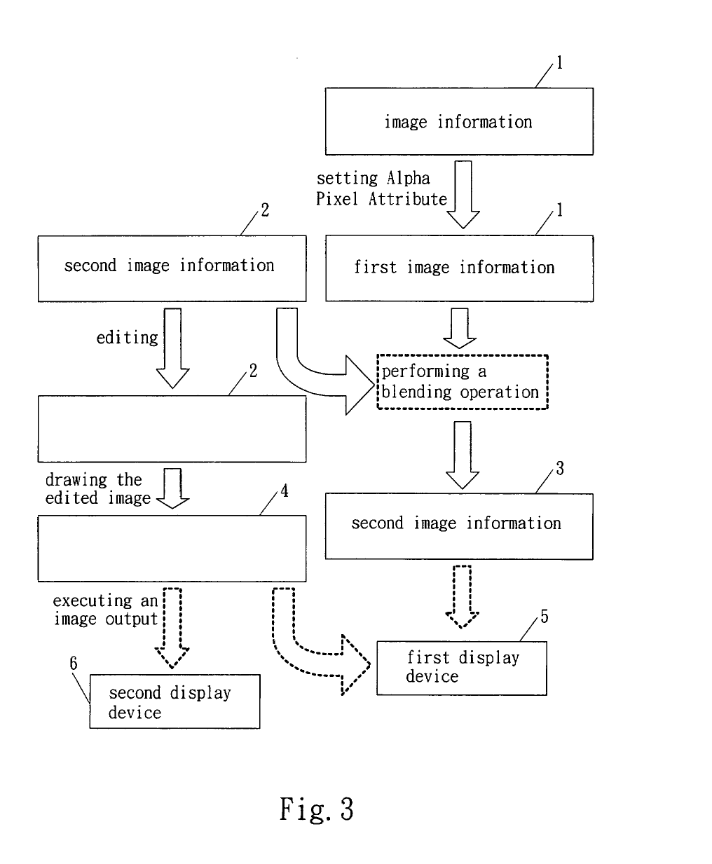

Please refer to FIG. 3, which is a schematic view showing the data structure of a second preferred embodiment according to the present invention. The difference of this embodiment, compared with the first embodiment, is that the hidden attribute is achieved by setting layers so that the image information can have displaying format and hidden format and through program setting, the image information in the hidden format can be displayed only on the first display device 5 by a mask effect. The editing method for computer includes steps of:

acquiring a first image information 1 (S1), wherein the first image information 1 is defined to have a hidden attribute, in which the hidden attribute of the first image information 1 is a layer parameter;

making the first image information 1 to have a hiding format through setting the hiding attribute of the first image information 1 (S2), in which the first image information 1 is set to be a first layer parameter so as to have the hidden format;

acquiring a second image information 2 with a displaying format (S3), wherein the second image information has a displaying format through setting the hidden attribute, in which the second image information 2 is set to be a second layer parameter so as to have the displaying format;

acquiring the first image information 1 in the hidden format and the second image information 2 in the displaying format to perform a blending operation for producing a third image information 3 in a displaying format to output to a first display device 5 (S4), wherein the displaying picture of the third image information 3 includes the first image information 1 and the second image information 2 which go through the image operation and has the second layer parameter, in which the third image information 3 is constituted by lapping and blending the first image information 1 and the second image information 2;

editing the second image information 2 in the displaying format through the third image information 3 in the displaying format displayed on the first display device 5 (S5); and

drawing the edited second image information 2 to produce a drawn image information 4 having the second layer parameter (S6), in which the drawing method of the second image information is to utilize mask effect to filter the image information in the hidden format, so as to obtain the second image information 2 in the displaying format (namely the second layer parameter).

Thereby, when editing the second image information 2, the user can refer to the third image information with the first image information contained therein shown on the first display device 5 so as to avoid the drawn image information 4 from containing the first image information 1.

Moreover, after drawing, the edited second image information 2 can, like the first embodiment, execute an image output (S7), which utilizes a second display device 6 to show the edited second image information 2, wherein, of course, the drawn image information 2 also can be displayed on the first display device 5, for example, the first display device 5 can utilize the PIP (picture in picture), for instance, to show the third image information 3 and the edited second image information 2 at the same time, or can be switched to display the third image information 3 (please refer to FIG. 10) or the edited second image information 2.

It should be notice that, in this embodiment, the first/second layer parameters make the image information to have hidden/displaying formats and the first/second layer parameters can be any displaying value of the image information, for example, if the image information is the 32-bit VGA, then the first layer parameter with the hidden format can be the 8-bit red image pixel attribute set to be 10˜50, the 8-bit green image pixel attribute set to be 60˜90, the 8-bit blue image pixel attribute set to be 30˜70, and the 8-bit alpha pixel attribute set to be 0 (namely, {R is 10˜50}+{G is 60˜90}+{B is 30˜70}+{A is 0}, so as to make the image information to have a displaying format. The second layer parameter is a pixel attribute other than the first layer parameter.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A copying and editing method in a computer, comprising steps of:
acquiring a first image information, wherein the first image information is defined to have a hiding attribute;
making the first image information to have a hiding format through setting the hiding attribute of the first image information;
acquiring a second image information with a displaying format, wherein the second image information is defined to have a hiding attribute and is set to have a displaying format through setting the hidden attribute;
acquiring the first image information in the hidden format and the second image information in the displaying format to perform a blending operation for producing a third image information in a displaying format to output to a first display device, wherein the displaying picture of the third image information comprises the first image information and the second image information which go through the image operation;
editing the second image information in the displaying format through the third image information in the displaying format displayed on the first display device; and
drawing the edited second image information to produce a drawn image information in the displaying format, thereby, as editing the second image information, the third image information which is displayed on the first display device and contains the first image information acts as reference, so as to avoid the drawn image information from containing the first image information.

2. The method as claimed in claim 1, wherein the first image information and the second image information are VGA (Video Graphics Array), and the displaying attribute is a RGB image pixel attribute which is constituted by a red image pixel attribute, a green image pixel attribute and a blue image pixel attribute and the hiding attribute is an alpha pixel attribute.

3. The method as claimed in claim 2, wherein the first image information is set to be the hidden format through setting the hiding attribute of the first image information as non-zero.

4. The method as claimed in claim 2, wherein the second image information is set to be the displaying format through setting the alpha pixel attribute of the second image information as zero.

5. The method as claimed in claim 2, wherein the image operation is a blending operation.

6. The method as claimed in claim 2, wherein the third image information is constituted by lapping and blending the first image information and the second image information.

7. The method as claimed in claim 2, wherein the second image information is drawn by only drawing the image information which has the displaying format before blending.

8. The method as claimed in claim 1, wherein the hidden attributes of the first image information and the second image information are layer parameters.

9. The method as claimed in claim 8, wherein the first image information is set to have a first layer parameter so as to have the hidden format.

10. The method as claimed in claim 8, wherein the second image information is set to have a second layer parameter so as to have the displaying format.

11. The method as claimed in claim 8, wherein the image operation is a layer blending.

12. The method as claimed in claim 8, wherein the displaying picture of the third image information is formed by lapping and blending the layers of the first image information and the second image information.

13. The method as claimed in claim 8, wherein the second image information is drawn by utilizing a mask effect which filters the image information with the hidden format, so as to obtain the second image information with the displaying format.

14. The method as claimed in claim 2, wherein the first image information is a draft information provided to the user for reference.

15. The method as claimed in claim 2, wherein the second image information is an editing image provided to the user for editing.

16. The method as claimed in claim 2, wherein the second image information is edited by character writing and/or figure drawing.

17. The method as claimed in claim 2, wherein the edited second image information is drawn by continuous image information recording and/or independent image information drawing.

18. The method as claimed in claim 2, wherein the drawn image information is displayed on a second display device.

19. The method as claimed in claim 2, wherein the drawn image information and the third image information are displayed on the first display device through picture switching.

20. The method as claimed in claim 2, wherein the drawn image information and the third image information are displayed on the first display device at the same time through utilizing a PIP (picture in picture) mode.
